(19) United States
(12) Patent Application Publication
(10) Pub. No.: US 2014/0308591 A1
(43) Pub. Date: Oct. 16, 2014

(54) ALKALI METAL-OXYGEN CELL HAVING A TITANATE ANODE

(71) Applicants: Samsung SDI Co., Ltd., Yongin-si (KR); Robert Bosch GmbH, Stuttgart (DE)

(72) Inventors: Ulrich Alkemade, Leonberg (DE); Thomas Wöhrle, München (DE); Joachim Fetzer, Bad-Ditzenbach (DE)

(73) Assignees: Samsung SDI Co., Ltd., Yongin-si (KR); Robert Bosch GmbH, Stuttgart (DE)

(21) Appl. No.: 14/220,855

(22) Filed: Mar. 20, 2014

(30) Foreign Application Priority Data
Apr. 16, 2013 (DE) 10 2013 206 740.2

(51) Int. Cl. H01M 12/08

(52) U.S. Cl. CPC H01M 12/08
USPC 429/405; 429/535

(57) ABSTRACT

An alkali metal-oxygen cell includes a negative electrode, an oxygen electrode, and a separator configured to conduct alkali metal ions. To improve the cycling stability of the negative electrode and also the cycling stability, the life, the high-current loading capability, the pulse loading capability and the safety behavior of the cell, the negative electrode includes at least one alkali metal titanate. In particular the at least one alkali metal titanate is one into or from which an alkali metal can reversibly be intercalated and deintercalated.

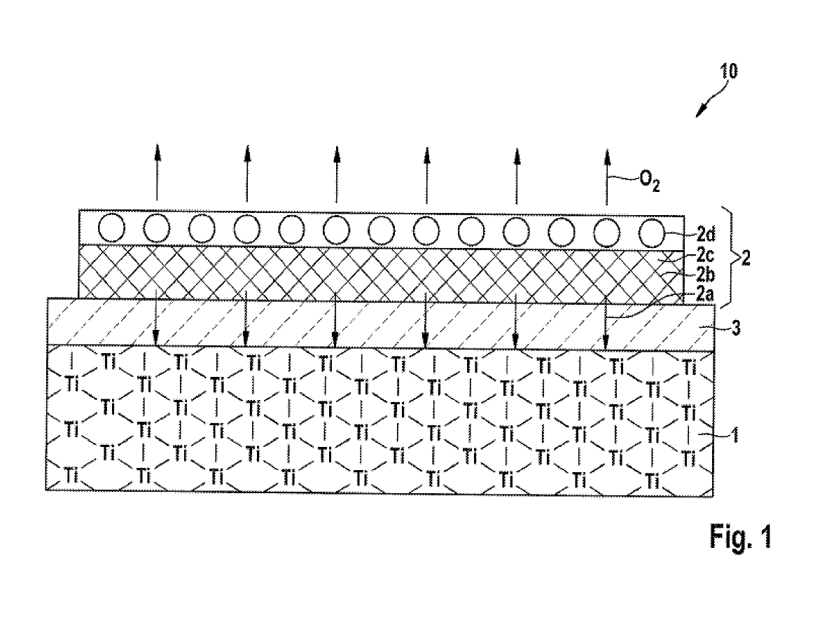

This application claims priority under 35 U.S.C. §119 to patent application number DE 10 2013 206 740.2, filed on Apr. 16, 2013 in Germany, the disclosure of which is incorporated herein by reference in its entirety.

### BACKGROUND

The present disclosure relates to an alkali metal-oxygen cell, for example a lithium-oxygen cell or sodium-oxygen cell, a process for producing it and its use.

Lithium-oxygen cells and rechargeable lithium-oxygen batteries, which are also referred to as lithium-air cells and rechargeable lithium-air batteries, are at present the subject of worldwide development activities since they enable higher energy densities compared to lithium ion technology to be achieved.

In lithium-oxygen cells, oxygen (O₂) is reacted at the positive electrode (cathode). The reaction of oxygen occurs at an oxygen- or air-permeable electrode, known as an oxygen electrode, which can be based, for example, on a porous carbon. The negative electrode (anode) in lithium-oxygen cells is customarily based on metallic lithium.

The document U.S. Pat. No. 5,510,209 describes a lithium-oxygen cell having a negative electrode composed of metallic lithium, an oxygen electrode composed of porous carbon and a polymer electrolyte which serves as separator and lithium ion conductor.

However, metallic lithium as anode material is generally not stable to cycling. Thus, for example, metallic lithium can precipitate in sponge-like form and/or in the form of dendrites and/or react with electrolytes during charging, which can, inter alia, lead to safety problems.

### SUMMARY

The present disclosure provides an alkali metal-oxygen cell which comprises a negative electrode, an oxygen electrode and a separator which conducts alkali metal ions, in particular between the negative electrode and the oxygen electrode.

For the purposes of the present disclosure, an alkali metal-oxygen cell is, in particular, an electrochemical cell, for example a battery or rechargeable battery, in which an alkali metal serves as active material of the negative electrode (anode) and oxygen or air serves as active material of the positive electrode (cathode). An alkali metal-oxygen cell can be, for example, a lithium-oxygen cell or lithium-air cell or a sodium-oxygen cell or sodium-air cell.

According to the disclosure, the negative electrode comprises at least one alkali metal titanate, in particular an alkali metal titanate into or from which an alkali metal can be reversibly intercalated and deintercalated. The alkali metal titanate can advantageously act as intercalation material and make it possible to dispense with the use of a metallic alkali metal, for example metallic lithium or sodium, in the negative electrode. Thus, problems associated with the use of metallic alkali metals, e.g. dendrite growth, sponge formation, electrolyte interactions and also volume changes, for example associated with crack formation, during charging/discharging, which could in the case of conventional alkali metal-oxygen cells lead to reduced cycling stability, life and/or safety problems, can advantageously be avoided. Thus, the cycling stability of the negative electrode and the cycling stability, the life and the safety behavior of the cell can in turn be improved. In addition, alkali metal titanates can advantageously conduct alkali metal ions and electrons. The kinetics of the alkali metal ion conduction can advantageously be sufficiently fast to provide a cell having high power capability and in particular to achieve sufficient high-current loading capability and improved pulse loading capability, in particular during charging and discharging. In addition, alkali metal titanates can provide a host structure which is structurally stable during the intercalation and deintercalation of alkali metals and in particular is also mechanically stable and does not participate in an undesirable manner in the electrochemical reaction. This not only has a positive effect on the cycling stability and life but also advantageously makes it possible to make the negative electrode of alkali metal titanate and, for example, dispense with other components in the negative electrode and achieve a high energy density.

In an embodiment, the negative electrode comprises at least one alkali metal titanate having a spinel structure. Particularly good results have advantageously been able to be achieved by means of alkali metal titanates having a spinel structure. The spinel structure allows, in particular, fast kinetics, i.e. lithium ions can be incorporated and released quickly, as a result of which a high load capability can advantageously be realized.

In a further embodiment, the alkali metal-oxygen cell is a lithium-oxygen cell. Here, the negative electrode can comprise, in particular, at least one lithium titanate, into which, in particular, the lithium can be reversibly intercalated and deintercalated. In addition, the separator can, in particular, conduct lithium ions. Lithium-oxygen cells advantageously have a high voltage and energy density.

In a specific variant of this embodiment, the negative electrode comprises a lithium titanate which in the discharged state of the cell has the general chemical formula Li₄Ti₅O₁₂ or Li[Li_{1/3}Ti_{5/3}]O₄(Li₄Ti₅O₁₂=3 Li[Li_{1/3}Ti_{5/3}]O₄; spinel structure). In the charged state of the cell, the lithium titanate can have the general chemical formula Li₂[Li_{1/3}Ti_{5/3}]O₄. When using such a lithium titanate, the electrochemical reaction of the discharging process can be formulated as follows:

2Li₂[Li_{1/3}Ti_{5/3}]O₄+O₂→Li₂O₂+Li[Li_{1/3}Ti_{5/3}]O₄

This electrochemical reaction has, relative to a metallic lithium anode (reference electrode), a redox potential E₀ of 1.50 V. Although the redox potential E₀ of this electrochemical reaction is therefore lower than the redox potential relative to a metallic lithium anode (reference electrode) E₀ of the electrochemical reaction:

2Li+O₂→Li₂O₂

of a conventional lithium-oxygen cell, which is about 3.10 V, but this is compensated for by the other advantages indicated at the outset, for example in respect of safety, cyclic stability and high-current flow capability.

In another embodiment, the alkali metal-oxygen cell is a sodium-oxygen cell. Here, the negative electrode can, in particular, comprise at least one sodium titanate, into which, in particular, sodium can be reversibly intercalated and deintercalated. In addition, the separator can conduct sodium ions.

The oxygen electrode can, in particular, be oxygen-permeable or air-permeable.

In a further embodiment, the oxygen electrode in the discharged state of the cell comprises alkali metal ions and/or at least one compound containing alkali metal ions. For example, the oxygen electrode in the discharged state of the cell can comprise an alkali metal peroxide. During the first charging of the cell, the alkali metal ions can be provided from the oxygen electrode, which are, for example, present there in the form of an alkali metal oxide, for example Li₂O₂ or Na₂O₂, migrate from the oxygen electrode through the separator which conducts alkali metal ions and into the negative electrode and there be intercalated or incorporated into the alkali metal titanate, for example into the spinel structure of the latter. In this way, the alkali metal titanate can be loaded with alkali metal ions. For example, in the case of a cell having a negative electrode based on Li₄Ti₅O₁₂ (Li₄Ti₅O₁₂=3 Li[Li_{1/3}Ti_{5/3}]O₄; spinel structure) and an Li₂O₂-containing oxygen electrode, the electrochemical reaction during charging can be formulated as follows:

Li[Li_{1/3}Ti_{5/3}]O₄+Li₂O₂→2Li₂[Li_{1/3}Ti_{5/3}]O₄+O₂

This process can be reversed during discharging.

If the cell is a lithium-oxygen cell, the oxygen electrode in the discharged state of the cell can comprise, in particular, lithium ions and/or at least one compound containing lithium ions. For example, the oxygen electrode in the discharged state of the cell can comprise lithium peroxide (Li₂O₂).

If the cell is a sodium-oxygen cell, the oxygen electrode in the discharged state of the cell can comprise, in particular, sodium ions and/or at least one compound containing sodium ions. For example, the oxygen electrode in the discharged state of the cell can comprise sodium peroxide (Na₂O₂).

In a further embodiment, the oxygen electrode comprises a carbon matrix. The carbon matrix can, in particular, be gas-permeably porous, in particular oxygen-permeably or air-permeably porous, and electrically conductive. For example, the carbon matrix can be made up of a material selected from the group consisting of carbon black, in particular conductive carbon black, graphite, in particular conductive graphite, carbon nanotubes and mixtures thereof.

In a further embodiment, the oxygen electrode further comprises a catalyst, in particular for catalyzing the reaction of oxygen, and/or an oxygen-permeable membrane. If the oxygen electrode comprises an oxygen-permeable membrane, this can, in particular, form the outermost layer of the oxygen electrode. If the oxygen electrode comprises a catalyst, this can, for example, be provided in hollow spaces in the carbon matrix and/or in the carbon matrix itself.

In a further embodiment, the separator comprises a ceramic material which conducts alkali metal ions. The separator can optionally be made of a ceramic material which conducts alkali metal ions.

If the cell is a lithium-oxygen cell, the separator can comprise, in particular, a ceramic material which conducts lithium ions. The separator can optionally be made of a ceramic material which conducts lithium ions.

If the cell is a sodium-oxygen cell, the separator can comprise, in particular, a ceramic material which conducts sodium ions. The separator can optionally be made of a ceramic material which conducts sodium ions.

As regards further advantages and technical features of the alkali metal-oxygen cell of the disclosure, explicit reference is hereby made to the explanations in connection with the production process of the disclosure and of the use according to the disclosure and also to the figures and the description of the figures.

The present disclosure further provides a process for producing an alkali metal-oxygen cell, in particular an alkali metal-oxygen cell according to the disclosure, for example a lithium-oxygen cell or sodium-oxygen cell. In the process, in particular, a negative electrode comprising at least one alkali metal titanate, an oxygen electrode and a separator which conducts alkali metal ions are provided. The separator can, in particular, be provided or arranged between the negative electrode and the oxygen electrode.

If a lithium-oxygen cell is produced by the process, a negative electrode comprising at least one lithium titanate, an oxygen electrode and a separator which conducts lithium ions can, in particular, be provided.

If a sodium-oxygen cell is produced by the process, a negative electrode comprising at least one sodium titanate, an oxygen electrode and a separator which conducts sodium ions can, in particular, be provided.

In an embodiment of the process, an oxygen electrode which comprises alkali metal ions and/or at least one compound containing alkali metal ions, in particular an alkali metal peroxide, is provided.

If a lithium-oxygen cell is produced by the process, it is possible, in particular, to provide an oxygen electrode which comprises lithium ions and/or at least one compound containing lithium ions, for example lithium peroxide (Li₂O₂).

If a sodium-oxygen cell is produced by the process, it is possible to provide, in particular, an oxygen electrode which comprises sodium ions and/or at least one compound containing sodium ions, for example sodium peroxide (Na₂O₂).

In a further embodiment of the process, the oxygen electrode comprises alkali metal ions in a stoichiometric amount which is greater than or equal to, in particular essentially equal to, a maximum stoichiometric amount of alkali metal which can be intercalated into the at least one alkali metal titanate. For example, the oxygen electrode can comprise the alkali metal ions in a stoichiometric amount which is essentially equal to a maximum stoichiometric amount of alkali metal which can be intercalated into the at least one alkali metal titanate.

If a lithium-oxygen cell is produced by the process, the oxygen electrode can, in particular, comprise lithium ions in a stoichiometric amount which is greater than or equal to a maximum stoichiometric amount of lithium which can be intercalated into the at least one lithium titanate. For example, the oxygen electrode can comprise the lithium ions in a stoichiometric amount which is essentially equal to a maximum stoichiometric amount of lithium which can be intercalated into the at least one lithium titanate.

If a sodium-oxygen cell is produced by the process, the oxygen electrode can, in particular, comprise the sodium ions in a stoichiometric amount which is greater than or equal to a maximum stoichiometric amount of sodium which can be intercalated into the at least one sodium titanate. For example, the oxygen electrode can comprise sodium ions in a stoichiometric amount which is essentially equal to a maximum stoichiometric amount of sodium which can be intercalated into the at least one sodium titanate. A cell having a suitable amount of alkali metal can advantageously be produced in this way.

In a further embodiment, the alkali metal-oxygen cell, for example lithium-oxygen cell or sodium-oxygen cell, is charged, in particular activated, before the first use. In particular, the alkali metal-oxygen cell, for example lithium-oxygen cell or sodium-oxygen cell, can be activated, for example alternately charged and discharged again a plurality of times, before the first use.

As regards further advantages and technical features of the process of the disclosure, explicit reference is hereby made to the explanations in connection with the alkali metal-oxygen cell of the disclosure and the use according to the disclosure and also to the figures and the description of the figures.

The disclosure further provides for the use of a cell according to the disclosure as alkali metal-oxygen cell, for example lithium-oxygen cell and/or sodium-oxygen cell, for example as battery, for example as secondary battery or rechargeable battery.

As regards further advantages and technical features of the use according to the disclosure, explicit reference is hereby made to the explanations in connection with the alkali metal-oxygen cell of the disclosure and the production process of the disclosure and also to the figures and the description of the figures.

### BRIEF DESCRIPTION OF THE DRAWINGS

Further advantages and advantageous embodiments of the subject matter of the disclosure are illustrated in the drawing and explained in the following description. It should be noted here that the drawing has only descriptive character and is not intended to restrict the disclosure in any way. It shows

FIGURE a schematic cross section through an embodiment of an alkali metal-oxygen cell according to the disclosure.

### DETAILED DESCRIPTION

The FIGURE shows an embodiment of an alkali metal-oxygen cell 10 according to the disclosure during the charging process. The cell 10 can be, for example, a lithium-oxygen cell or a sodium-oxygen cell. In particular, the cell 10 can be a lithium-oxygen cell.

The FIGURE shows that the cell 10 comprises a negative electrode 1, an oxygen electrode 2 and a separator 3, in particular ceramic separator 3, which conducts alkali metal ions and is arranged between the negative electrode 1 and the oxygen electrode 2. The structuring of the negative electrode 1 indicates that the negative electrode 1 comprises an alkali metal titanate. Depending on whether the cell 10 is a lithium-oxygen cell or a sodium-oxygen cell, the alkali metal titanate can be a lithium titanate or a sodium titanate. Correspondingly, the separator 3 can conduct lithium ions in the case of a lithium-oxygen cell 10 and conducts sodium ions in the case of a sodium-oxygen cell 10. Alkali metal ions, for example lithium ions or sodium ions, can be reversibly intercalated into and deintercalated again from the alkali metal titanate, for example lithium titanate or sodium titanate. In this way, the alkali metal titanate, for example lithium titanate or sodium titanate, functions as intercalation material for the alkali metal ions, for example lithium ions or sodium ions, which makes it possible to dispense with a metallic anode material, for example metallic lithium or sodium, and avoid problems associated therewith, e.g. dendrite growth and electrolyte interactions. The cycling stability of the negative electrode 1 and also the cycling stability, the life, the high-current loading capability, the pulse loading capability and the safety behavior of the cell 10 can advantageously be significantly improved as a result.

The arrows 2a pointing in the direction of the negative electrode 1 in the FIGURE indicate that the oxygen electrode 2 in the discharged state of the cell 10 comprises alkali metal ions, for example lithium ions or sodium ions, for example in the form of an alkali metal peroxide 2a, for example lithium peroxide (Li₂O₂) or sodium peroxide (Na₂O₂), which during the charging process move through the separator 3 to the negative electrode 1 and are there intercalated into the alkali metal titanate, for example lithium titanate or sodium titanate. At the same time, oxygen ions are oxidized to oxygen O₂ at the oxygen electrode 2 during the charging process and this oxygen flows out on the side of the oxygen electrode 2.

Furthermore, the FIGURE shows that the oxygen electrode 2 comprises a carbon matrix 2b. The carbon matrix 2b can, in particular, be oxygen-permeably porous and electrically conductive. For example, the carbon matrix 2b can be made of carbon black, graphite or carbon nanotubes.

The FIGURE indicates that the oxygen electrode 2 further comprises a catalyst 2c which is arranged in hollow spaces of the carbon matrix 2b and/or in the carbon matrix 2b itself.

The FIGURE also shows that the oxygen electrode 2 can optionally also have an oxygen-permeable membrane 2d, which can, in particular, form the outermost layer of the oxygen electrode 2.

What is claimed is:

1. An alkali metal-oxygen cell, comprising:
a negative electrode;
an oxygen electrode; and
a separator configured to conduct alkali metal ions,
wherein the negative electrode includes at least one alkali metal titanate into which or from which an alkali metal is reversibly intercalated and deintercalated.

2. The alkali metal-oxygen cell according to claim 1, wherein the negative electrode includes at least one alkali metal titanate having a spinel structure.

3. The alkali metal-oxygen cell according to claim 1, wherein:
the alkali metal-oxygen cell is a lithium-oxygen cell,
the negative electrode includes at least one lithium titanate, and
the separator is configured to conduct lithium ions.

4. The alkali metal-oxygen cell according to claim 1, wherein:
the negative electrode includes a lithium titanate, and
in the discharged state of the cell, the lithium titanate has the general chemical formula Li₄Ti₅O₁₂ or Li[Li_{1/3}Ti_{5/3}]O₄.

5. The alkali metal-oxygen cell according to claim 1, wherein:
the alkali metal-oxygen cell is a sodium-oxygen cell,
the negative electrode includes at least one sodium titanate, and
the separator is configured to conduct sodium ions.

6. The alkali metal-oxygen cell according to claim 1, wherein the oxygen electrode in the discharged state of the cell includes at least one of alkali metal ions and at least one compound containing alkali metal ions.

7. The alkali metal-oxygen cell according to claim 1, wherein the oxygen electrode in the discharged state of the cell includes an alkali metal peroxide.

8. The alkali metal-oxygen cell according to claim 1, wherein the oxygen electrode includes a carbon matrix.

9. The alkali metal-oxygen cell according to claim 8, wherein the carbon matrix is made of one of carbon black, graphite, carbon nanotubes and mixtures thereof.

10. The alkali metal-oxygen cell according to claim 1, wherein the oxygen electrode further includes at least one of a catalyst and an oxygen-permeable membrane.

11. The alkali metal-oxygen cell according to claim 1, wherein the separator includes a ceramic material configured to conduct alkali metal ions.

12. A process for producing an alkali metal-oxygen cell, comprising:
arranging a separator between a negative electrode and an oxygen electrode,
wherein the negative electrode includes at least one alkali metal titanate, and
wherein the separator is configured to conduct alkali metal ions.

13. The process according to claim 12, wherein the oxygen electrode includes at least one of alkali metal ions and at least one compound containing alkali metal ions.

14. The process according to claim 13, wherein the oxygen electrode includes the alkali metal ions in a stoichiometric amount which is greater than or equal to a maximum stoichiometric amount of alkali metal able to be intercalated into the at least one alkali metal titanate.

15. The process according to claim 12, further comprising charging the alkali metal-oxygen cell before a first use.

16. The alkali metal-oxygen cell according to claim 4, wherein, in the charged state of the cell, the lithium titanate has the general chemical formula Li₂[Li_{1/3}Ti_{5/3}]O₄.

17. The alkali metal-oxygen cell according to claim 7, wherein the alkali metal peroxide is one of lithium peroxide and sodium peroxide.

18. The process according to claim 13, wherein the at least one of alkali metal ions and at least one compound containing alkali metal ions is one of lithium peroxide and sodium peroxide.

19. The process according to claim 15, wherein charging the alkali metal-oxygen cell includes activating the alkali metal-oxygen cell before the first use.
